(19) United States
(12) Patent Application Publication
(10) Pub. No.: US 2022/0048783 A1
(43) Pub. Date: Feb. 17, 2022

(54) Production of High Purity Lithium Carbonate from Brines

(71) Applicant: LANXESS Deutschland GmbH, Cologne (DE)

(72) Inventors: Dirk Steinhilber, Neuss (DE); Stefan Neufeind, Siegburg (DE); Shintaro Tzusuki, Cologne (DE); Joachim Kralik, Leichlingen (DE)

(73) Assignee: LANXESS Deutschland GmbH, Cologne (DE)

(21) Appl. No.: 17/299,022

(22) PCT Filed: Dec. 16, 2019
(86) PCT No.: PCT/EP2019/085245

§ 371 Date: Jun. 2, 2021

(30) Foreign Application Priority Data
Dec. 20, 2018 (EP) 18214613.4

(51) Int. Cl. C01D 15/08

(52) U.S. Cl. CPC C01D 15/08; C01P 2006/80

(57) ABSTRACT

The invention relates to a process for the preparation of high-purity lithium carbonate from brines.

The invention relates to a process for the preparation of high-purity lithium carbonate from brines.

Lithium carbonate is an important material for the production of lithium-ion batteries. Lithium-ion batteries are used as energy storage means in electric vehicles, mobile radio devices and grid storage means. The production of lithium-ion batteries requires the use of high-purity lithium, as contamination reduce the capacity and lifetime of the batteries.

Lithium can in particular be obtained from brines, which may be contaminated by alkaline earth metals such as magnesium and calcium, but also by potassium, chloride, bromide or borate.

Natural brines form the basis for 66% of worldwide lithium reserves. However, such brines generally contain only very low amounts of lithium. For example, the brine from the Great Salt Lake in Utah contains only about 34 to 66 ppm of lithium. Other natural salt solutions, such as for example those originating from mines or other sources from the groundwater, may contain up to 0.5% by weight of lithium. Such concentrated salt solutions are, however, rare.

The preparation of high-purity lithium from brines is therefore technically highly complex and economically very expensive.

Traditional techniques for the preparation of lithium carbonate stipulate that firstly the water in the brine is evaporated further with the aid of solar irradiation, then the salt impurities, in particular magnesium hydroxide and calcium hydroxide, are salted out and then removed by means of filtration. This process is extremely time-intensive and is therefore not satisfactorily employable commercially for covering the increasing demand for high-purity lithium. U.S. Pat. No. 4,243,392 discloses the use of this process for the preparation of high-purity lithium chloride, from which then initially lithium carbonate and, in the course of the further process, by means of electrolysis high-purity lithium can be obtained.

U.S. Pat. No. 4,980,136 describes a process for the preparation of lithium chloride having a degree of purity of >99%, in which firstly the magnesium impurities are precipitated by means of evaporating the water from the lithium-containing brine and then the lithium is extracted by means of alcohols, especially with the aid of isopropanol. The lithium chloride can then be obtained in high purity by means of crystallization from the alcohol mixture. A disadvantage with this process is the large dimensions of the installations, which are of only limited suitability for ecological and economic reasons.

Inorganic ion exchangers are used for the adsorption and removal of lithium ions. For example, DE-A 19541558 discloses the purification of lithium chloride solutions formed from brines comprising sodium zeolite X by ion exchange of lithium ions.

U.S. Pat. No. 5,599,516 describes the use of polycrystalline, hydrated aluminium compositions for obtaining high-purity lithium from brines.

U.S. Pat. Nos. 4,859,343 and 4,929,588 disclose the use of crystalline antimonic acid for the removal of contamination, in particular of magnesium, calcium and sodium ions, from brines in order to obtain high-purity lithium.

U.S. Pat. No. 4,381,349 describes the use of weakly basic anion exchangers on which aluminium hydroxide has been deposited for the recovery of lithium ions.

It is a disadvantage with the processes above that the inorganic materials possess a low mechanical and chemical stability and thus can be used only for a few adsorption cycles.

The use thereof in industrial processes is therefore also placed at an ecological and economic disadvantage.

“The recovery of pure lithium chloride from “brines” containing higher contents of calcium chloride and magnesium chloride”, Hydrometallurgy, 27 (1991), pages 317 to 325, discloses the adsorption of lithium ions on iminodiacetic acid resins and aminomethyl resins. In this document, however, these resins are used with the aim of removing impurities from brines. The obtaining of high-purity lithium by adsorption and elution of the lithium ions bound on an iminodiacetic resin or an aminomethyl resin and their conversion to lithium carbonate is not described.

DE-A 19809420 describes a process for the preparation of high-purity lithium carbonate, in which a mixture of lithium carbonate and water is initially converted into lithium hydrogencarbonate by means of addition of carbon dioxide and this mixture is then passed through an ion exchanger module composed of weakly and also strongly acidic cation exchangers or composed of chelating resins containing aminoalkylenephosphonic acid groups or iminodiacetic acid groups in order thereby to remove impurities, and then the lithium carbonate is precipitated and removed.

An additional disadvantage with the existing processes is that they are technologically complex to implement, and therefore unnecessarily large amounts of resources are wasted, and entail high costs, that is to say they cannot be carried out satisfactorily in terms of economics.

The object was therefore that of providing a process for the preparation of lithium carbonate, with which the disadvantages of the prior art could be overcome.

A process has surprisingly been found which uses specifically functionalized chelating resins that can be used not only to remove magnesium, calcium or sodium ions, but also adsorb lithium ions in large amounts, by means of which lithium carbonate can be obtained in high purity.

The invention therefore provides a process for the preparation of lithium carbonate, characterized in that

in a first process step a.), the calcium and magnesium ions are precipitated from a brine containing at least lithium ions, calcium and magnesium ions by means of addition of a precipitant, generating a supernatant, and then

in a process step b.), the supernatant from a.) is contacted with at least one chelating resin containing functional groups of structural element (I)

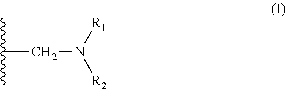

in which [symbol] is the polystyrene copolymer skeleton and R₁ and R₂ independently of one another are —CH₂COOX, —CH₂PO(OX¹)₂, —CH₂PO(OH)OX², —(CS)NH₂, —CH₂-pyridyl or hydrogen, where R₁ and R₂ cannot both simultaneously be hydrogen and X, X¹ and X² independently of one another are hydrogen, sodium or potassium, and

in a process step c.), the mobile phase from process step b.) is contacted with at least one chelating resin containing functional groups of structural element (I)

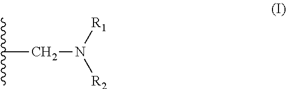

in which [symbol] and R₁ and R₂ have the meanings given in process step b.), and

in a process step d.), the lithium adsorbed on the chelating resin containing functional groups of structural element (I) in process step c.) is eluted by addition of inorganic acids and the eluate is optionally adjusted to a pH>7 and optionally recycled back into process step c.) and

in a process step e.), the lithium-containing eluate from process step d.) is admixed with at least one carbonate or with carbon dioxide or the acid thereof.

With the aid of the inventive process, lithium carbonate is prepared preferably in a purity of at least 95% by weight based on the total weight of the lithium carbonate. With the aid of the inventive process, lithium carbonate is particularly preferably prepared in a purity of at least 99% by weight based on the total weight of the lithium carbonate. With the aid of the inventive process, lithium carbonate is very particularly preferably prepared in a purity of at least 99.5% by weight based on the total weight of the lithium carbonate.

Within the context of the invention, lithium-containing brines are aqueous salt solutions that contain lithium ions. The lithium-containing brine preferably contains lithium ions at a concentration by weight of 0.1 ppm to 5000 ppm. The lithium-containing brine particularly preferably contains lithium ions at a concentration by weight of 0.1 ppm to 1000 ppm.

In a further preferred embodiment of the invention, the lithium-containing brine contains lithium ions at a concentration by weight of 0.1 ppm to 5000 ppm, sodium ions at a concentration by weight of 0.1 ppm to 100 g/l and calcium ions at a concentration by weight of 0.1 ppm to 100 g/l and magnesium ions at a concentration by weight of 0.1 ppm to 100 g/l.

In a further particularly preferred embodiment of the invention, the lithium-containing brine contains lithium ions at a concentration by weight of 0.1 ppm to 1000 ppm, sodium ions at a concentration by weight of 0.1 ppm to 100 g/l and calcium ions at a concentration by weight of 0.1 ppm to 100 g/l and magnesium ions at a concentration by weight of 0.1 ppm to 100 g/l.

In a further preferred embodiment of the invention, the lithium-containing brine contains strontium ions at a concentration by weight of 0.1 ppm to 100 g/l.

In a further preferred embodiment, 1 l to 10 l of lithium-containing brine are used in process step a.).

Preferred precipitants used in process step a.) for precipitating the calcium and magnesium ions are metal sulfates, metal hydrogensulfates, metal oxalates, metal hydroxides, metal hydrogencarbonates, metal carbonates, sulfuric acid, oxalic acid, sulfurous acid or carbon dioxide. The metals used may be any metals of groups IA, IIA, IIIB, IVB, VB, VIB, VIIB, VIIIB, IB, IIB of the periodic table and the lanthanides. Particularly preferred precipitants used are alkali metal oxalates such as in particular sodium oxalate and potassium oxalate, alkali metal sulfates such as in particular sodium sulfate or potassium sulfate, alkali metal carbonates such as in particular sodium carbonate and potassium carbonate, alkali metal hydroxides such as in particular sodium hydroxide and potassium hydroxide, sulfuric acid, oxalic acid, sulfurous acid or carbon dioxide. The precipitant used in process step a.) is very particularly preferably sodium carbonate, sodium hydroxide and/or mixtures of these compounds.

The precipitation in process step a.) can be effected at room temperature. Preferably, the precipitation is effected at a temperature of 40° C. to 80° C.

The molar ratio of precipitant to calcium and magnesium ions is preferably 5:1 to 1:5, particularly preferably 3:1 to 1:1.

The supernatant removed in process step a.) contains the major proportion of lithium ions. The supernatant removed in process step a.) preferably has a pH of 10 to 12. The precipitation in process step a.) is preferably carried out in the presence of a base. Preferably, the precipitant in process step a.) already has basic properties, so that no further base needs to be added. If the precipitation is carried out in the presence of a base, the supernatant preferably has a pH of 10 to 12. If no base is added as precipitant, the supernatant can be adjusted to a pH of 10 to 12 by addition of a base. Bases used for adjusting the pH of the supernatant or additional bases used in process step a.) are preferably alkali metal hydroxides such as in particular sodium carbonate, sodium hydroxide and potassium hydroxide, or mixtures of these bases.

As a result of the precipitation step in process step a.), the concentration by weight of calcium and magnesium ions is preferably reduced to 10 ppm to 100 ppm. In a particularly preferred embodiment of the invention, the concentration by weight of calcium and magnesium ions is reduced in process step a.) to 10 ppm to 30 ppm.

In a further preferred embodiment of the invention, the content of strontium ions in the supernatant is reduced in process step a.) to 10 ppm to 100 ppm, particularly preferably to 1 to 5 ppm.

In a further preferred embodiment of the invention, the ratio of the concentration by weight of lithium ions that are present in the supernatant a.) and used in process step b.) to the concentrations by weight of magnesium and calcium ions is 100:1 to 1:1, particularly preferably 20:1 to 5:1.

In a further preferred embodiment of the invention, the lithium-containing supernatant from process step a.), which is used in process step b.), contains lithium ions at a concentration by weight of 0.1 ppm to 500 ppm, sodium ions at a concentration by weight of 0.1 ppm to 100 g/l and calcium ions at a concentration by weight of 1 ppm to 100 ppm.

In a further preferred embodiment of the invention, the lithium-containing supernatant from process step a.) contains lithium ions at a concentration by weight of 0.1 ppm to 500 ppm, sodium ions at a concentration by weight of 0.1 ppm to 100 g/l and magnesium ions at a concentration by weight of 1 ppm to 100 ppm.

In process step b.), the supernatant from process step a.) is contacted with at least one chelating resin containing functional groups of structural element (I). Within the context of the invention, “contacted” is preferably understood to mean the addition of the supernatant to the chelating resin, located in a column, containing functional groups of structural element (I). However, the chelating resin containing functional groups of structural element (I) can also be added to the supernatant within the scope of a batch process. The chelating resin is then preferably removed from the supernatant by filtration or the supernatant is decanted off. The supernatant is then transferred to process step c.).

Preferably, R₁ and R₂ in the chelating resin containing functional groups of structural element (I) used in process step b.) and/or the chelating resin containing functional groups of structural element (I) used in process step c.) independently of one another=—CH₂PO(OX¹)₂, —CH₂PO(OH)OX², CH₂COOX or hydrogen, where R₁ and R₂ cannot both simultaneously be hydrogen and X, X¹ and X² independently of one another are hydrogen, sodium or potassium. Particularly preferably, R₁=hydrogen, —CH₂PO(OX¹)₂ or —CH₂PO(OH)OX² and R₂═—CH₂PO(OX²)₂ or —CH₂PO(OH)OX². Very particularly preferably, R₁=hydrogen and R₂═—CH₂PO(OX²)₂ or —CH₂PO(OH)OX². X, X¹ and X² independently of one another are hydrogen, sodium or potassium. X, X¹ and X² independently of one another are preferably sodium. X¹ and X² are preferably identical.

Examples of preferred polystyrene copolymers used in the chelating resin containing functional groups of structural element (I) include copolymers of styrene, vinyltoluene, ethylstyrene, α-methylstyrene, chlorostyrene or chloromethylstyrene and mixtures of these monomers with polyvinylaromatic compounds (crosslinkers), such as preferably divinylbenzene, divinyltoluene, trivinylbenzene, divinylnaphthalene or trivinylnaphthalene.

The polystyrene copolymer skeleton used is particularly preferably a styrene/divinylbenzene-crosslinked copolymer.

In the polystyrene copolymer skeleton, the —CH₂—NR₁R₂ group is bonded to a phenyl radical.

The chelating resins used in accordance with the invention and containing functional groups of structural element (I) preferably have a macroporous structure.

The terms “microporous” or “in gel form”/“macroporous” have already been described exhaustively in the technical literature, for example, in Seidl, Malinsky, Dusek, Heitz, Adv. Polymer Sci., 1967, Vol. 5, pp. 113 to 213. The possible methods of measurement for macroporosity, for example mercury porosimetry and BET determination, are likewise described therein. The pores of the macroporous bead polymers of the chelating resins used in accordance with the invention and containing functional groups of structural element (I) generally and preferably have a diameter of 20 nm to 100 nm.

The chelating resins used in accordance with the invention and containing functional groups of structural element (I) preferably have a monodisperse distribution.

In the present application, monodisperse materials are those in which at least 90% by volume or % by mass of the particles have a diameter within ±10% of the most common diameter.

For example, in the case of a material having a most common diameter of 0.5 mm, at least 90% by volume or % by mass is within a size range between 0.45 mm and 0.55 mm; in the case of a material having a most common diameter of 0.7 mm, at least 90% by volume or by mass is within a size range between 0.77 mm and 0.63 mm.

The chelating resins used in the process and containing functional groups of structural element (I) are preferably prepared by:
1) converting monomer droplets composed of at least one monovinylaromatic compound and at least one polyvinylaromatic compound and at least one initiator into a bead polymer,
2) phthalimidomethylating the bead polymer from step a) with phthalimide derivatives,
3) converting the phthalimidomethylated bead polymer from step b) into an aminomethylated bead polymer and optionally in a further step
4) functionalizing the aminomethylated bead polymer to give a chelating resin having functional groups of formula (I).

In process step 1), at least one monovinylaromatic compound and at least one polyvinylaromatic compound are used. However, it is also possible to use mixtures of two or more monovinylaromatic compounds and mixtures of two or more polyvinylaromatic compounds.

Within the context of the present invention, preferred monovinylaromatic compounds used in process step 1) are styrene, vinyltoluene, ethylstyrene, α-methylstyrene, chlorostyrene or chloromethylstyrene.

Especially preferably, styrene or mixtures of styrene with the aforementioned monomers, preferably with ethylstyrene, is used.

Preferred polyvinylaromatic compounds within the context of the present invention for process step 1) are divinylbenzene, divinyltoluene, trivinylbenzene, divinylnaphthalene, or trivinylnaphthalene, especially preferably divinylbenzene.

The polyvinylaromatic compounds are preferably used in amounts of 1%-20% by weight, particularly preferably 2%-12% by weight, especially preferably 4%-10% by weight, based on the monomer or mixture thereof with further monomers. The nature of the polyvinylaromatic compounds (crosslinkers) is selected with regard to the later use of the bead polymer. If divinylbenzene is used, commercial grades of divinylbenzene containing not only the isomers of divinylbenzene but also ethylvinylbenzene are sufficient.

The term “bead polymer” within the context of the invention is a spherical crosslinked polymer.

Macroporous bead polymers are preferably formed by addition of inert materials, preferably at least one porogen, to the monomer mixture in the course of polymerization in order to produce a macroporous structure in the bead polymer. Especially preferred porogens are hexane, octane, isooctane, isododecane, methyl ethyl ketone, butanol or octanol and isomers thereof. Especially suitable organic substances are those which dissolve in the monomer but are poor solvents or swellants for the bead polymer (precipitants for polymers), for example aliphatic hydrocarbons (Farbenfabriken Bayer DBP 1045102, 1957; DBP 1113570, 1957).

U.S. Pat. No. 4,382,124 uses, as porogen, the alcohols having 4 to 10 carbon atoms which are likewise to be used with preference in the context of the present invention for the preparation of monodisperse, macroporous bead polymers based on styrene/divinylbenzene. In addition, an overview of the preparation methods for macroporous bead polymers is given.

Preferably, at least one porogen is added in process step 1).

The bead polymers prepared in process step 1) can be prepared in heterodisperse or monodisperse form.

The preparation of heterodisperse bead polymers is accomplished by general processes known to those skilled in the art, for example with the aid of suspension polymerization.

Preference is given to preparing monodisperse bead polymers in process step a).

In a preferred embodiment of the present invention, in process step 1), microencapsulated monomer droplets are used in the preparation of monodisperse bead polymers.

Useful materials for the microencapsulation of the monomer droplets are those known for use as complex coacervates, especially polyesters, natural and synthetic polyamides, polyurethanes or polyureas.

A natural polyamide that is preferably used is gelatin. This is employed especially as a coacervate and complex coacervate. Gelatin-containing complex coacervates within the context of the invention are to be understood as meaning, in particular, combinations of gelatin with synthetic polyelectrolytes. Suitable synthetic polyelectrolytes are copolymers having incorporated units of, for example, maleic acid, acrylic acid, methacrylic acid, acrylamide and methacrylamide. Particular preference is given to using acrylic acid and acrylamide. Gelatin-containing capsules may be hardened with conventional hardeners, for example formaldehyde or glutardialdehyde. The encapsulation of monomer droplets with gelatin, gelatin-containing coacervates and gelatin-containing complex coacervates is described in detail in EP 0 046 535 A. The methods for encapsulation with synthetic polymers are known. Preference is given to an interfacial condensation in which a reactive component (in particular an isocyanate or an acid chloride) dissolved in the monomer droplet is reacted with a second reactive component (in particular an amine) dissolved in the aqueous phase.

The heterodisperse or optionally microencapsulated, monodisperse monomer droplets contain at least one initiator or mixtures of initiators (initiator combination) to trigger the polymerization. Initiators preferred for the process according to the invention are peroxy compounds, especially preferably dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane or tert-amylperoxy-2-ethylhexane, and also azo compounds such as 2,2′-azobis(isobutyronitrile) or 2,2′-azobis(2-methylisobutyronitrile).

The initiators are preferably employed in amounts of 0.05% to 2.5% by weight, more preferably 0.1% to 1.5% by weight, based on the monomer mixture.

The optionally monodisperse, microencapsulated monomer droplet may optionally also contain up to 30% by weight (based on the monomer) of crosslinked or uncrosslinked polymer. Preferred polymers derive from the aforementioned monomers, particularly preferably from styrene.

In the preparation of monodisperse bead polymers in process step 1), the aqueous phase in a further preferred embodiment may contain a dissolved polymerization inhibitor. Useful inhibitors in this case include both inorganic and organic substances. Preferred inorganic inhibitors are nitrogen compounds, especially preferably hydroxylamine, hydrazine, sodium nitrite and potassium nitrite, salts of phosphorous acid such as sodium hydrogen phosphite, and sulfur-containing compounds such as sodium dithionite, sodium thiosulfate, sodium sulfite, sodium bisulfite, sodium thiocyanate and ammonium thiocyanate. Examples of organic inhibitors are phenolic compounds such as hydroquinone, hydroquinone monomethyl ether, resorcinol, catechol, tert-butylcatechol, pyrogallol and condensation products of phenols with aldehydes. Further preferred organic inhibitors are nitrogen-containing compounds. Especially preferred are hydroxylamine derivatives, for example N,N-diethylhydroxylamine, N-isopropylhydroxylamine and sulfonated or carboxylated N-alkylhydroxylamine or N,N-dialkylhydroxylamine derivatives, hydrazine derivatives, for example N,N-hydrazinodiacetic acid, nitroso compounds, for example N-nitrosophenylhydroxylamine, N-nitrosophenylhydroxylamine ammonium salt or N-nitrosophenylhydroxylamine aluminium salt. The concentration of the inhibitor is 5-1000 ppm (based on the aqueous phase), preferably 10-500 ppm, particularly preferably 10-250 ppm.

The polymerization of the optionally microencapsulated, monodisperse monomer droplets to afford the monodisperse bead polymer is optionally/preferably effected in the presence of one or more protective colloids in the aqueous phase. Suitable protective colloids are natural or synthetic water-soluble polymers, preferably gelatin, starch, polyvinyl alcohol, polyvinylpyrrolidone, polyacrylic acid, polymethacrylic acid or copolymers of (meth)acrylic acid and (meth)acrylic esters. Preference is further given to cellulose derivatives, especially cellulose esters and cellulose ethers, such as carboxymethyl cellulose, methyl hydroxyethyl cellulose, methyl hydroxypropyl cellulose and hydroxyethyl cellulose. Gelatin is especially preferred. The amount of protective colloid used is generally 0.05% to 1% by weight based on the aqueous phase, preferably 0.05% to 0.5% by weight.

The polymerization to give the monodisperse bead polymer can in an alternative preferred embodiment be conducted in the presence of a buffer system. Preference is given to buffer systems which adjust the pH of the aqueous phase at the start of the polymerization to a value between 14 and 6, preferably between 12 and 8. Under these conditions, protective colloids having carboxylic acid groups are fully or partly present in the form of salts. This has a favourable effect on the action of the protective colloids. Buffer systems of particularly good suitability contain phosphate or borate salts. The terms “phosphate” and “borate” within the context of the invention also encompass the condensation products of the ortho forms of corresponding acids and salts. The concentration of the phosphate or borate in the aqueous phase is for example 0.5-500 mmol/l and preferably 2.5-100 mmol/l.

The stirrer speed in the polymerization to give the monodisperse bead polymer is less critical and, in contrast to conventional bead polymerization, has no effect on the particle size. Low stirrer speeds sufficient to keep the suspended monomer droplets in suspension and to promote the removal of the heat of polymerization are employed. Various stirrer types can be used for this task. Particularly suitable stirrers are gate stirrers having axial action.

The volume ratio of encapsulated monomer droplets to aqueous phase is preferably 1:0.75 to 1:20, particularly preferably 1:1 to 1:6.

The polymerization temperature for the monodisperse bead polymer is guided by the decomposition temperature of the initiator used. It is preferably between 50 to 180° C., particularly preferably between 55 and 130° C. The polymerization preferably lasts 0.5 to about 20 hours. It has proved useful to employ a temperature program in which the polymerization is commenced at low temperature, for example 60° C., and the reaction temperature is raised as the polymerization conversion progresses. In this way, for example, the requirement for reliable reaction progress and a high polymerization conversion can be fulfilled very efficiently. After the polymerization, the monodisperse bead polymer is isolated by conventional methods, for example by filtering or decanting, and optionally washed.

The preparation of the monodisperse bead polymers with the aid of the jetting principle or the seed-feed principle is known from the prior art and described, for example, in U.S. Pat. No. 4,444,961, EP-A 0 046 535, U.S. Pat. No. 4,419,245 or WO 93/12167.

The monodisperse bead polymers are preferably prepared with the aid of the jetting principle or the seed-feed principle.

Preference is given to preparing, in process step 1), a macroporous, monodisperse bead polymer.

In process step 2), preference is given to initially preparing the amidomethylation reagent. To this end, for example, a phthalimide or a phthalimide derivative is dissolved in a solvent and admixed with formalin. A bis(phthalimido) ether is subsequently formed therefrom, with elimination of water. Preferred phthalimide derivatives within the context of the present invention are phthalimide itself or substituted phthalimides, for example methylphthalimide. However, in process step 2), the phthalimide derivative/the phthalimide could also be reacted with the bead polymer from step 1) in the presence of paraformaldehyde.

The molar ratio of the phthalimide derivatives to the bead polymers in process step 2) is generally 0.15:1 to 1.7:1, with other amount-of-substance ratios also being selectable. The phthalimide derivative is preferably used in process step 2) in an amount-of-substance ratio of 0.7:1 to 1.45:1.

Formalin is typically used in excess based on the phthalimide derivative, but other amounts may also be used. Preference is given to using 1.01 to 1.02 mol of formalin per mole of phthalimide derivative.

Inert solvents suitable for swelling the polymer are generally used in process step 2), preferably chlorinated hydrocarbons, particularly preferably dichloroethane or methylene chloride. However, processes that can be conducted without the use of solvents are also conceivable.

In process step 2), the bead polymer is condensed with phthalimide derivatives. The catalyst used here is preferably oleum, sulfuric acid or sulfur trioxide, in order therefrom to prepare an SO₃ adduct of the phthalimide derivative in the inert solvent.

In process step 2), the catalyst is typically added in deficiency with respect to the phthalimide derivative, although larger amounts can also be used. Preferably, the molar ratio of the catalyst to the phthalimide derivatives is between 0.1:1 and 0.45:1. Particularly preferably, the molar ratio of the catalyst to the phthalimide derivatives is between 0.2:1 and 0.4:1.

Process step 2) is performed at temperatures between preferably 20 to 120° C., particularly preferably of 60° C. to 90° C.

The cleavage of the phthalic acid radical and thus the exposure of the aminomethyl group is effected in process step 3) preferably by treating the phthalimidomethylated crosslinked bead polymer with aqueous or alcoholic solutions of an alkali metal hydroxide, such as sodium hydroxide or potassium hydroxide, at temperatures of 100° C. and 250° C., preferably 120° C.-190° C. The concentration of the sodium hydroxide solution is preferably 20% by weight to 40% by weight. This process makes it possible to prepare bead polymers containing aminoalkyl groups.

The aminomethylated bead polymer thus formed is generally washed with demineralized water until free of alkali. However, it may also be used without aftertreatment.

The aminomethyl group-containing bead polymers obtained in process step 3) are converted into the chelating resins containing functional groups of structural element (I) by commonly used processes known to those skilled in the art.

Preference is given to preparing the chelating resins used in accordance with the invention and containing functional groups of structural element (I), where R₁ and R₂ independently of one another=—CH₂COOX or H, but R₁ and R₂ cannot simultaneously be hydrogen and X is hydrogen, sodium or potassium, by reacting the aminomethyl group-containing bead polymer from process step 3) in aqueous suspension with chloroacetic acid or derivatives thereof. An especially preferred chloroacetic acid derivative is the sodium salt of chloroacetic acid.

The sodium salt of chloroacetic acid is preferably used as an aqueous solution.

The aqueous solution of the sodium salt of chloroacetic acid is metered at the reaction temperature into the initially charged aqueous suspension of the aminomethyl group-containing, sulfonated bead polymer preferably within 0.5 to 15 hours. The metered addition is particularly preferably effected within 5 to 11 hours.

The hydrochloric acid liberated in the reaction of the aminomethyl group-containing bead polymers with chloroacetic acid is partially or fully neutralized by addition of sodium hydroxide solution, so that the pH of the aqueous suspension in this reaction is set within the range preferably between pH 5 to 10.5. The reaction is particularly preferably conducted at pH 9.5.

The reaction of the aminomethyl group-containing bead polymers with chloroacetic acid is conducted at temperatures preferably within the range between 50 and 100° C. The reaction of the aminomethyl group-containing bead polymers with chloroacetic acid is particularly preferably effected at temperatures within the range between 80 and 95° C.

The suspension medium used is preferably water or aqueous salt solution. Useful salts include alkali metal salts, especially NaCl and sodium sulfate.

The average degree of substitution of the amine groups of the chelating resin containing functional groups of structural element (I), where R₁ and R₂ independently of one another=—CH₂COOX or H, but R₁ and R₂ cannot simultaneously be hydrogen and X is hydrogen, sodium or potassium, is preferably 1.4 to 1.9.

The average degree of substitution indicates the statistical ratio between unsubstituted, monosubstituted and disubstituted amino groups. The average degree of substitution can therefore be between 0 and 2. At a degree of substitution of 0, no substitution would have taken place and the amine groups of structural element (I) would be present as primary amino groups. At a degree of substitution of 2, all amino groups in the resin would be present in disubstituted form. At a degree of substitution of 1, all the amino groups in the resin would be present in monosubstituted form from a statistical viewpoint.

Preference is given to preparing the chelating resins used in accordance with the invention and containing functional groups of structural element (I), where R₁ and R₂ independently of one another=—CH₂PO(OX¹)₂, —CH₂PO(OH)OX² or are hydrogen, but cannot both simultaneously be hydrogen and X¹ and X² independently of one another is hydrogen, sodium or potassium, by reacting the aminomethyl group-containing bead polymer from process step 3) in sulfuric acid-containing suspension with formalin in combination with P—H acidic (according to modified Mannich reaction) compounds, preferably with phosphorous acid, monoalkyl phosphorous esters or dialkyl phosphorous esters.

Particular preference is given to using formalin in combination with P—H acidic compounds, such as phosphorous acid or dimethyl phosphite.

The conversion of the aminomethyl group-containing bead polymer into chelating resins containing functional groups of structural element (I), in the case where R₁ and R₂ independently of one another=—CH₂PO(OX¹)₂, —CH₂PO(OH)OX² or are hydrogen, but cannot both simultaneously be hydrogen and X¹ and X² independently of one another is hydrogen, sodium or potassium, is preferably effected at temperatures in the range from 70 to 120° C., particularly preferably at temperatures in the range between 90 and 110° C.

The average degree of substitution of the amine groups of the chelating resin containing functional groups of structural element (I), where R₁ and R₂ independently of one another=—CH₂PO(OX¹)₂, —CH₂PO(OH)OX² or are hydrogen, but cannot both simultaneously be hydrogen and X¹ and X² independently of one another is hydrogen, sodium or potassium, is preferably 1.4 to 2.0. Particularly preferably, the average degree of substitution of the amine groups of the chelating resin containing functional groups of structural element (I), where R₁ and R₂ independently of one another=—CH₂PO(OX¹)₂, —CH₂PO(OH)OX² or are hydrogen, but cannot both simultaneously be hydrogen and X¹ and X² independently of one another is hydrogen, sodium or potassium, is 1.4 to 1.9. Preference is given to preparing the inventive chelating resin containing functional groups of structural element (I), where R₁ and R₂ independently of one another=—CH₂-pyridyl or are hydrogen, but cannot both simultaneously be hydrogen, in process step 4) by reacting the bead polymer from process step 3) in aqueous suspension with chloromethylpyridine or the hydrochloride thereof or with 2-chloromethylquinoline or 2-chloromethylpiperidine.

Chloromethylpyridine/the hydrochloride thereof may be used in the form of 2-chloromethylpyridine, 3-chloromethylpyridine or 4-chloromethylpyridine.

When structural element (I) is a —CH₂-pyridyl radical, the reaction in process step 4) is preferably effected while maintaining a pH within the range of 4 to 9, and is preferably conducted with the addition of alkali, particular preferably of potassium hydroxide solution or sodium hydroxide solution, especially preferably of sodium hydroxide solution. By means of addition of alkali during the reaction of the aminomethyl group-containing, sulfonated bead polymer from process step 3) in aqueous suspension with picolyl chloride or the hydrochloride thereof, the pH is preferably maintained within the range 4-9 during the reaction. The pH is particularly preferably maintained within the range 6-8.

If structural element (I) is a picolylamine radical, the reaction in process step 4) is preferably effected in the temperature range from 40 to 100° C., particularly preferably in the temperature range from 50 to 80° C. The process described in steps 1) to 3) is known as the phthalimide process. Besides the phthalimide process, there is also the option of preparing an aminomethylated bead polymer with the aid of the chloromethylation process. According to the chloromethylation process, described for example in EP-A 1 568 660, firstly bead polymers—usually based on styrene/divinyl benzene—are prepared, chloromethylated and subsequently reacted with amines (Helfferich, Ionenaustauscher [Ion Exchangers], pages 46-58, Verlag Chemie, Weinheim, 1959) and also EP-A 0 481 603). The ion exchanger comprising polymer having functional groups of formula (I) can be prepared by the phthalimide process or by the chloromethylation process. The inventive ion exchanger is preferably prepared by the phthalimide process, as per process steps 1) to 3), and is then optionally functionalized to give the chelating resin as per step 4).

In a further embodiment of the invention, a macroporous, monodisperse chelating resin containing functional groups of structural element (I) is used in process step b.). In this case, R₁ and R₂ independently of one another=—CH₂PO(OX¹)₂, —CH₂PO(OH)OX² or hydrogen, where both cannot simultaneously be hydrogen and X¹ and X² independently of one another hydrogen, sodium or potassium. The bead polymer of the chelating resin containing functional groups of structural element (I) preferably has a diameter of 250 to 450 μm in process step b.).

In a further embodiment of the invention, a macroporous, monodisperse chelating resin containing functional groups of structural element (I) is used in process step c.). In this case, R₁ and R₂ independently of one another=—CH₂PO(OX¹)₂, —CH₂PO(OH)OX² or hydrogen, where both cannot simultaneously be hydrogen and X¹ and X² independently of one another hydrogen, sodium or potassium. The bead polymer of the chelating resin containing functional groups of structural element (I) preferably has a diameter of 250 to 450 μm in process step c.).

In a further embodiment of the invention, a macroporous, monodisperse chelating resin containing functional groups of structural element (I) is used in process step b.). In this case, R₁ and R₂ independently of one another=—CH₂COOX or H, but R₁ and R₂ are not simultaneously hydrogen and X is hydrogen, sodium or potassium. The bead polymer of the chelating resin containing functional groups of structural element (I) preferably has a diameter of 250 to 450 μm in process step b.).

In a further embodiment of the invention, a macroporous, monodisperse chelating resin containing functional groups of structural element (I) is used in process step c.). In this case, R₁ and R₂ independently of one another=—CH₂COOX or H, but R₁ and R₂ are not simultaneously hydrogen and X is hydrogen, sodium or potassium. The bead polymer of the chelating resin containing functional groups of structural element (I) preferably has a diameter of 250 to 450 μm in process step c.).

The total capacity of the macroporous, monodisperse chelating resin containing functional groups of structural element (I) is determined according to DIN 54403 (Testing of ion exchangers—determination of the total capacity of cation exchangers).

Macroporous, monodisperse chelating resin containing functional groups of structural element (I) preferably have a total capacity of 2.0 mold to 3.5 mold.

Preferably, the same chelating resins containing functional groups of structural element (I) are used in process steps b.) and c.).

As a result of process step b.), metal-containing impurities are in particular removed from the supernatant from process step a.). In a preferred embodiment, the concentrations by weight of the calcium and magnesium ions in the mobile phase from process step b.) are reduced to 5 ppb to 50 ppb, preferably to 5 ppb to 30 ppb. The concentrations by weight of lithium in the mobile phase from process step b.) are preferably 1 ppm to 500 ppm.

Preferably, 0.1% to 10% of the total capacity of the resin is occupied by lithium ions in process step b.).

In a further preferred embodiment, 2000 l to 20 000 l of purified brine from process step a.) are used per litre of resin in process step b.).

In a further preferred embodiment, the concentrations by weight of strontium ions in the mobile phase are reduced to 35 bbp to 50 bbp.

Within the context of the invention, “mobile phase” refers to the supernatant formed after the contacting with the chelating resin containing functional groups of structural element (I). This may for example be the supernatant formed within the scope of a batch process or, since the supernatant from process step a.) can also be applied to a column containing the chelating resin containing functional groups of structural element (I), may also be the mobile phase to be obtained therefrom.

In process step c.), the mobile phase from process step b.) is contacted with at least one chelating resin containing functional groups of structural element (I). Preferably, 100 l to 400 l of the mobile phase from process step b.) are used per litre of resin in process step c.). Loading of the chelating resin containing functional groups of structural element (I) with lithium from the mobile phase in process step c.) is preferably performed up until the time at which the chelating resin can no longer be loaded with lithium. 1 g to 20 g of lithium are preferably bound per litre of resin. Preferably 30% to 96% of the total capacity of the resin is covered with lithium in process step c.). Particularly preferably, 50% to 85% of the total capacity is occupied by lithium in process step c.).

In a preferred embodiment of the invention, the mobile phase from process step b) has a pH of 10 to 12 when it is contacted with the chelating resin containing functional groups of structural element (I). A pH of 10 to 12 is present preferably as a result of the fact that a basic precipitant is used. A base can preferably be added in order to adjust the pH. Preferred bases used to adjust the pH of the pH of the mobile phase from process step b.) are alkali metal hydroxides, such as in particular sodium carbonate, sodium hydroxide and potassium hydroxide or mixtures of these bases.

In a preferred embodiment of the invention, the mobile phase from process step b.) is recycled back onto the resin that was used in process step b.) but which has been regenerated. The mobile phase from process step b.) can particularly preferably be recycled into process step b.) at least twice.

For the regeneration of the chelating resin containing functional groups of structural element (I) from process step b.), this resin is preferably washed with demineralized water. After this, it is regenerated with acid, preferably regenerated with an inorganic acid, washed with water and conditioned with base. The base used is preferably NaOH. After this, the chelating resin containing functional groups of structural element (I) is washed, preferably once more with demineralized water, until free of alkali.

The lithium adsorbed on the chelating resin containing functional groups of structural element (I) is eluted in process step d.). The eluents used are inorganic acids. Inorganic acids that may be used are preferably sulfuric acid, nitric acid, phosphoric acid or hydrohalic acids, such as preferably hydrochloric acid and hydrofluoric acid. The inorganic acid used is particularly preferably hydrochloric acid. The inorganic acids are preferably used in process step d.) at a concentration of from 1% by weight to 10% by weight.

In process step d.), preference is given to firstly, prior to the elution, removing the supernatant from the chelating resin containing functional groups of structural element (I) by means of compressed air. This supernatant could also be removed by washing, for example by means of demineralized water. Preferably, the lithium is eluted thereafter by means of inorganic acids. Preferably, the chelating resin containing functional groups of structural element (I) is washed again thereafter by means of compressed air and washing with demineralized water. The eluate from process step d.) is preferably recycled multiple times into process step c.) in order to load the chelating resin containing functional groups of structural element (I). To this end, the eluate is adjusted to a pH>7 by way of addition of a base prior to the contacting with the chelating resin containing functional groups of structural element (I). Bases that could be used are any compounds that can function as bases according to the Lewis or Brønsted concept. Alkali metal or alkaline earth metal hydroxides or ammonium hydroxide or anion exchangers in hydroxide form could in particular be used. The pH of the eluate is preferably between 10 and 12. Preferred bases that are used for adjusting the pH of the eluate are alkali metal hydroxides, such as preferably with ammonium hydroxide, sodium hydroxide or potassium hydroxide, or mixtures of these bases. Particular preference is given to using sodium hydroxide. Particular preference is given to performing process step c.) at least five times with the eluate from process step d.). By returning the eluate to the column, the lithium is initially adsorbed on the column. Repetition of these steps results in a concentration of the lithium on the column.

The eluate from process step d.) preferably contains lithium ions at a concentration by weight of 1 g/l to 10 g/l, particularly preferably of 5 g/l to 10 g/l.

In a further embodiment of the invention, the eluate from process step d.) preferably contains lithium ions at a concentration by weight of 1 g/l to 10 g/l, sodium ions at a concentration by weight of 1 ppm to 100, preferably 50 g/l, and calcium and magnesium ions at a concentration by weight of 2 ppb to 20 ppb. In a further preferred embodiment, the eluate contains strontium ions at a concentration by weight of 1 ppb to 10 ppb.

The lithium salt obtained in process step d.) is converted into lithium carbonate in process step e.).

The lithium salt, preferably lithium chloride, is preferably converted into the lithium carbonate in process step e.) using an alkali metal carbonate. However, it may also be precipitated by addition of carbon dioxide or by addition of carbonic acid. Alkali metal carbonates used are preferably sodium carbonate, potassium carbonate or mixtures of these compounds. In a preferred embodiment of the invention, the alkali metal carbonate, preferably sodium carbonate, is first dissolved in water and then added to the eluate from process step e.). The lithium carbonate is then preferably removed by filtration and may then be dried.

The molar ratio of lithium content and alkali metal carbonate in process step e.) is preferably from 10:1 to 1:10, particularly preferably from 1:1 to 1:5.

The pH during the precipitation in process step e.) is preferably 9 to 12. The pH is preferably adjusted by using a basic precipitant, such as preferably alkali metal carbonates. However, the pH may also be adjusted to a pH of 9 to 12 by addition of a base, such as preferably sodium hydroxide or/and potassium hydroxide.

The precipitation in process step e.) is preferably effected at temperatures of 70° C. to 100° C., particularly preferably at temperatures of 80° C. to 95° C. The removal of the supernatant is effected by processes known from the prior art, such as preferably by filtration.

The lithium carbonate can be subjected to further purification processes, such as for example crystallization, or can be used directly for the preparation of lithium. The processes for crystallization of lithium carbonate are sufficiently well known to those skilled in the art. By means of crystallization, lithium carbonate can be obtained with a purity of at least 99.9%.

The lithium carbonate can be converted into elemental, high-purity lithium by electrolytic workup. Corresponding processes are known to those skilled in the art from the prior art.

In a particularly preferred embodiment, in process step a.), at least one lithium-containing brine containing

lithium ions at a concentration by weight of 0.1 ppm to 1000 ppm,

sodium ions at a concentration by weight of 0.1 ppm to 100 g/l and

calcium ions at a concentration by weight of 0.1 ppm to 100 g/l and

magnesium ions at a concentration by weight of 0.1 ppm to 100 g/l and

strontium ions at a concentration by weight of 0.1 ppm to 100 g/l

is mixed with a basic precipitant, preferably sodium carbonate, in a molar ratio of precipitant to magnesium and calcium ions of 3:1 to 1:1 and the precipitate is removed, preferably by filtration, and the supernatant containing

lithium ions at a concentration by weight of 0.1 ppm to 500 ppm,

sodium ions at a concentration by weight of 0.1 ppm to 100 g/l and

calcium ions at a concentration by weight of 10 ppm to 100 ppm and

magnesium ions at a concentration by weight of 10 ppm to 100 ppm and

strontium ions at a concentration by weight of 10 ppm to 100 ppm

is applied, in a process step b.), at a pH of 10 to 12 to a macroporous, monodisperse chelating resin containing functional groups of structural element (I) and the mobile phase from this process step b.) containing

lithium ions at a concentration by weight of 0.1 ppm to 500 ppm,

sodium ions at a concentration by weight of 0.1 ppm to 100 g/l and

calcium ions at a concentration by weight of 5 ppb to 50 ppb and

magnesium ions at a concentration by weight of 5 ppb to 50 ppb and

strontium ions at a concentration by weight of 5 ppb to 50 ppb

is applied, in a process step c.), at a pH of 10 to 12 to a macroporous, monodisperse chelating resin containing functional groups of structural element (I), wherein, possibly by means of repeated loading using the basic eluate from process step d.), 50% to 96% of the total capacity of the macroporous, monodisperse chelating resin containing functional groups of structural element (I) is loaded with lithium and then, in a process step d.), the lithium adsorbed in process step c.) on the chelating resin containing functional groups of structural element (I) is eluted by addition of inorganic acids, preferably by addition of HCl, this generating a lithium-containing solution containing

lithium ions at a concentration by weight of 1 g/l to 10 g/l,

sodium ions at a concentration by weight of 1 ppm to 100, preferably 50 g/l, and

calcium ions at a concentration by weight of 2 ppb to 20 ppb and

magnesium ions at a concentration by weight of 2 ppb to 20 ppb and

strontium ions at a concentration by weight of 1 ppb to 10 ppb,

and, in a process step e.), the lithium-containing eluate from process step d.) is admixed with at least one carbonate or with carbon dioxide or the acid thereof to prepare lithium carbonate in a purity of at least 99.5% by weight.

The inventive process makes it possible to obtain high-purity lithium carbonate from lithium-containing brines. An essential advantage of the inventive process consists in that, in a five-step system: 1.) precipitation 2.) further reduction of the calcium and magnesium content using a chelating resin 3.) concentration by means of lithium adsorption onto the chelating resin 4.) elution and 5.) conversion of the lithium salt into lithium carbonate, high-purity lithium carbonate can be obtained efficiently in economic terms with comparatively low technical complexity. In addition, the time required for the preparation can be considerably shortened, since no time-consuming evaporation processes using solar irradiation are required. Furthermore, the yield of lithium can be improved.

The following examples serve only for the description of the invention and are not intended to limit it.

### Methods

The ion concentration can be determined by processes known to those skilled in the art from the prior art. The ion concentration is preferably determined in the inventive process by means of an inductively coupled plasma (ICP) spectrometer.

The mobile phase from the ion exchanger column was in this case fractionated into 10 ml fractions and analysed by means of ICP and the ion concentration determined.

### EXAMPLE 1

### A) Removal of Calcium Ions, Magnesium Ions and Strontium Ions by Precipitation

To 1 l of brine (37 g/l of Ca²⁺, 3.7 g/l of Mg²⁺, 2.3 g/l of Sr²⁺, 65 g/l of Na⁺ and 140 ppm of Li⁺ (0.014 g/l) was added 0.32 l of a solution of Na₂CO₃ (400 g/l, 129.3 g) and 0.05 l of NaOH (1000 g/l, 48.8 g) at 60° C. over a period of 30 min. The brine and the precipitant were mixed here at a stirring rate of 350 rpm. The dispersion formed was filtered off over a filter funnel at a pressure of 2 bar. The purified brine contained Ca²⁺, Sr²⁺ and Mg²⁺ at a concentration of below 20 ppm and also 140 ppm of Li⁺ and had a pH of 11.

B) Removal of Ca²⁺, Sr²⁺ and Mg²⁺ by Means of an Aminomethylphosphonic Acid Group-Containing Chelating Resin

A measuring cylinder was filled with 50 ml of a macroporous, monodisperse chelating resin containing functional groups of structural element (I) where R₁ and R₂ independently of one another=—CH₂PO(OX¹)₂, —CH₂PO(OH)OX² or hydrogen, where both cannot simultaneously be hydrogen and X¹ and X²=hydrogen. The bead polymer of the chelating resin had a diameter of 430 μm. The average degree of substitution of the chelating resin used here and containing functional groups of structural element (I) is 2.0. The resin has a total capacity of 3.2 mold. The resin was then transferred into a 100 ml chromatography column having a diameter of 3 cm, with attention being paid to ensure that there were no air bubbles between the polymer beads. 267 l of the purified brine from A) was pumped onto the chromatography column at a pumping rate of 1000 ml/h. The resin was loaded in the process with 42 g of Ca²⁺, Sr²⁺ Mg²⁺ per litre of resin. Breakthrough was reached after 52 h and the obtained brine contained Ca²⁺, Sr²⁺ and Mg²⁺ at a concentration of below 20 ppb and the concentration of Li⁺ was additionally 140 ppm. After the brine was removed from the column by flushing with 4 BV (bed volumes) (1 BV=50 ml of resin) of demineralized water, the resin was regenerated with 2 BV of 7.5% HCl, 4 BV/h. Thereafter, the resin was washed again with 4 BV (1 BV=50 ml of resin) of demineralized water and converted into the sodium form with 2 BV of 4% NaOH, 4 BV/h.

### C) Lithium Adsorption and Concentration on the Aminomethylphosphonic Acid Group-Containing Chelating Resin

A measuring cylinder was filled with 50 ml of a macroporous, monodisperse chelating resin containing functional groups of structural element (I) where R₁ and R₂ independently of one another=—CH₂PO(OX¹)₂, —CH₂PO(OH)OX² or hydrogen, where both cannot simultaneously be hydrogen and X¹ and X²=hydrogen. The bead polymer of the chelating resin had a diameter of 430 μm. The average degree of substitution of the chelating resin used here and containing functional groups of structural element (I) is 2.0. The resin has a total capacity of 3.2 mold. The resin was then transferred into a 100 ml chromatography column having a diameter of 3 cm, with attention being paid to ensure that there were no air bubbles between the polymer beads.

9.2 l of the brine purified from B) was pumped onto the resin at a constant flow rate of 250 ml/h. The resin was loaded with 1.83 g of lithium per litre of resin and thus has a usable capacity of 1.83 g/l. 8% of the total capacity was therefore occupied by lithium. Breakthrough was reached after 4 h. After the brine was removed from the column by compressed air, the resin was regenerated with 1 BV of 7.5% HCl, 4 BV/h. The eluate was adjusted to a pH of 10.5 with sodium hydroxide and applied to the column again. This process was repeated 5 times, with 50%-96% of the total capacity being occupied by lithium. A solution having 7 g/l of lithium was obtained here, from which lithium chloride was obtained.

### D) Obtaining of Lithium Carbonate by Precipitation

The pH of the solution (1 l) that was obtained from the resin from C) by the regeneration and contained 7 g/l of lithium was adjusted to pH=10 by addition of NaOH. After this, 0.3 l 18 g of a 400 g/l solution of Na₂CO₃ was added at 90° C. and the Li₂CO₃ precipitated as a white solid. The mixture was filtered at 2 bar and 32.5 g of Li₂CO₃ was obtained with a purity of 99.5%. This corresponds to a yield of 88%.

### EXAMPLE 2

### A) Removal of Calcium Ions, Magnesium Ions and Strontium Ions by Precipitation

To 1 l of brine (37 g/l of Ca²⁺, 3.7 g/l of Mg²⁺, 2.3 g/l of Sr²⁺, 65 g/l of Na⁺ and 140 ppm of Li⁺ (0.014 g/l) was added 0.32 ml of a solution of Na₂CO₃ (400 g/l, 129.3 g) and 0.05 l of NaOH (1000 g/l, 48.8 g) at 60° C. over a period of 30 min. The brine and the precipitant were mixed here at a stirring rate of 350 rpm. The dispersion formed was filtered off over a filter funnel at a pressure of 2 bar. The purified brine contained Ca²⁺, Sr²⁺ and Mg²⁺ at a concentration of below 20 ppm and also 140 ppm of Li⁺ and had a pH of 11.

B) Removal of Ca²⁺, Sr²⁺ and Mg²⁺ by Means of an Iminodiacetic Acid Group-Containing Chelating Resin

A measuring cylinder was filled with 50 ml of a macroporous, monodisperse chelating resin containing functional groups of structural element (I) where R₁ and R₂ independently of one another=—CH₂COOX or H, but R₁ and R₂ cannot simultaneously be hydrogen and X is hydrogen. The bead polymer of the chelating resin has a diameter of 430 μm. The average degree of substitution of the chelating resin used here and containing functional groups of structural element (I) is 1.6. The resin has a total capacity of 2.8 mold. The resin was then transferred into a 100 ml chromatography column having a diameter of 3 cm, with attention being paid to ensure that there were no air bubbles between the polymer beads. 267 l of the purified brine from A) was pumped onto the chromatography column at a pumping rate of 1000 ml/h. The resin was loaded in the process with 42 g of Ca²⁺, Sr²⁺ Mg²⁺ per litre of resin. Breakthrough was reached after 52 h and the obtained brine contained Ca²⁺, Sr²⁺ and Mg²⁺ at a concentration of below 20 ppb and the concentration of Li⁺ was additionally 140 ppm. After the brine was removed from the column by flushing with 4 BV (bed volumes) (1 BV=50 ml of resin) of demineralized water, the resin was regenerated with 2 BV of 7.5% HCl, 4 BV/h. Thereafter, the resin was washed again with 4 BV (1 BV=50 ml of resin) of demineralized water and converted into the sodium form with 2 BV of 4% NaOH, 4 BV/h.

### C) Lithium Adsorption and Concentration on the Iminodiacetic Acid Group-Containing Chelating Resin

A measuring cylinder was filled with 50 ml of a macroporous, monodisperse chelating resin containing functional groups of structural element (I) where R₁ and R₂ independently of one another=—CH₂COOX or H, but R₁ and R₂ cannot simultaneously be hydrogen and X is hydrogen. The bead polymer of the chelating resin had a diameter of 430 μm. The average degree of substitution of the chelating resin used here and containing functional groups of structural element (I) is 1.6. The resin has a total capacity of 2.8 mold. The resin was then transferred into a 100 ml chromatography column having a diameter of 3 cm, with attention being paid to ensure that there were no air bubbles between the polymer beads.

9.2 l of the brine purified from B) was pumped onto the resin at a constant flow rate of 250 ml/h. The resin was loaded with 1.75 g of lithium per litre of resin and thus has a usable capacity of 1.75 g/l. 9% of the total capacity was therefore occupied by lithium. Breakthrough was reached after 4 h. After the brine was removed from the column by compressed air, the resin was regenerated with 1 BV of 7.5% HCl, 4 BV/h. The eluate was adjusted to a pH of 10.5 with sodium hydroxide and applied to the column again. This process was repeated 5 times, with 50%-96% of the total capacity being occupied by lithium. A solution having 7 g/l of lithium was obtained here, from which lithium chloride was obtained.

### D) Obtaining of Lithium Carbonate by Precipitation

The pH of the solution (1 l) that was obtained from the resin from C) by the regeneration and contained 7 g/l of lithium was adjusted to pH=10 by addition of NaOH. After this, 0.3 l 18 g of a 400 g/l solution of Na₂CO₃ was added at 90° C. and the Li₂CO₃ precipitated as a white solid. The mixture was filtered at 2 bar and 32.5 g of Li₂CO₃ was obtained with a purity of 99.5%. This corresponds to a yield of 88%.

1. Process for the preparation of lithium carbonate, comprising the steps of:
step a.) precipitating calcium and magnesium ions from a brine containing at least lithium ions, calcium and magnesium ions by adding a precipitant, generating a supernatant, and then
step b.) contacting the supernatant from step a.) with at least one chelating resin containing functional groups of structural element (I) 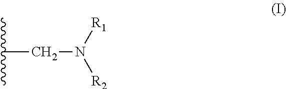
in which [symbol] is a polystyrene copolymer skeleton and R₁ and R₂ independently of one another are —CH₂COOX, —CH₂PO(OX¹)₂, —CH₂PO(OH)OX², —(CS)NH₂, —CH₂-pyridyl or hydrogen, where R₁ and R₂ cannot both simultaneously be hydrogen, and X, X¹ and X² independently of one another are hydrogen, sodium or potassium, generating a mobile phase, and
step c.) contacting the mobile phase from step b.) with at least one chelating resin containing functional groups of structural element (I) 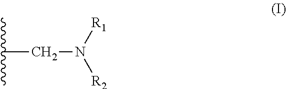
in which [symbol] and R₁ and R₂ have the meanings given in step b.), and
step d.) eluting lithium adsorbed on the chelating resin containing functional groups of structural element (I) in step c.) by adding inorganic acids, generating a lithium-containing eluate and
step e.) admixing the lithium-containing eluate from step d.) with at least one carbonate or with carbon dioxide or the acid thereof.

2. The process according to claim 1, wherein the lithium carbonate is prepared with a purity of at least 99% by weight.

3. The process according to claim 1, wherein the lithium-containing brine contains lithium at a concentration by weight of 0.1 ppm to 5000 ppm.

4. The process according to claim 1, wherein the lithium-containing brine contains lithium at a concentration by weight of 0.1 ppm to 1000 ppm.

5. The process according to claim 1, wherein the lithium-containing brine contains lithium at a concentration by weight of 0.1 ppm to 5000 ppm and sodium at a concentration by weight of 0.1 ppm to 100 g/l and calcium at a concentration by weight of 0.1 ppm to 100 g/l and magnesium at a concentration by weight of 0.1 ppm to 100 g/l.

6. The process according to claim 1, wherein the precipitant used in process step a.) is sodium carbonate, sodium hydroxide or mixtures of these compounds.

7. The process according to claim 1, wherein the molar ratio of precipitant to calcium and magnesium ions in process step a.) is 3:1 to 1:1.

8. The process according to claim 7, wherein in process step a.) a basic precipitant is used or a base is added to the precipitant and as a result the supernatant from process step a.), which is used in process step b.), has a pH of 10 to 12.

9. The process according to claim 1, wherein R₁ and R₂ in the chelating resin containing functional groups of structural element (I) used in process step b.) and/or the chelating resin containing functional groups of structural element (I) used in process step c.) independently of one another=—CH₂PO(OX¹)₂, —CH₂PO(OH)OX², CH₂COOX or hydrogen, where R₁ and R₂ cannot both simultaneously be hydrogen and X, X¹ and X² independently of one another are hydrogen, sodium or potassium.

10. The process according to claim 9, wherein R₁ and R₂ in the chelating resin containing functional groups of structural element (I) used in process step b.) and/or the chelating resin containing functional groups of structural element (I) used in process step c.) independently of one another=—CH₂PO(OX¹)₂, —CH₂PO(OH)OX² or hydrogen, where R₁ and R₂ cannot both simultaneously be hydrogen and X, X¹ and X² independently of one another are hydrogen, sodium or potassium.

11. The process according to claim 9, wherein the bead polymer of the chelating resin containing functional groups of structural element (I) is monodisperse and macroporous, and the bead polymer has a diameter of 250 μm to 450 μm.

12. The process according to claim 7, wherein the concentrations by weight of calcium and magnesium in the mobile phase from process step b.) is 5 ppb to 50 ppb.

13. The process according to claim 8, wherein the mobile phase from process step b), which is used in process step c.), has a pH of 10 to 12.

14. The process according to claim 1, wherein in process step d.) hydrochloric acid is used as inorganic acid for the elution.

15. The process according to claim 1, wherein the eluate from process step d.) contains lithium at a concentration by weight of 1 g/l to 10 g/l and calcium and magnesium ions 2 ppb to 20 ppb and contains sodium at a concentration by weight of 1 ppm to 50 g/l.

16. The process according to claim 1, wherein the lithium-containing eluate from step d.) is adjusted to a pH>7.

17. The process according to claim 1, wherein the lithium-containing eluate from step d.) is recycled back into step c.).
